(19) United States
(12) Patent Application Publication
(10) Pub. No.: US 2015/0120583 A1
(43) Pub. Date: Apr. 30, 2015

(54) PROCESS AND MECHANISM FOR IDENTIFYING LARGE SCALE MISUSE OF SOCIAL MEDIA NETWORKS

(71) Applicant: The MITRE Corporation, McLean, VA (US)

(72) Inventor: Jeffrey ZARRELLA, McLean, VA (US)

(73) Assignee: The MITRE Corporation, McLean, VA (US)

(21) Appl. No.: 14/063,555

(22) Filed: Oct. 25, 2013

(51) Int. Cl. G06Q 30/00; G06Q 50/00

(52) U.S. Cl. CPC G06Q 30/018; G06Q 50/01
USPC 705/317

(57) ABSTRACT

The described systems and methods compare behavior between multiple users of social media services to determine coordinated activity. An index is created and used to extract uncommon features from social media messages. A collision between users is detected when their messages have the same uncommon feature. A number and/or frequency of collisions may indicate a probability that users are engaged in coordinated activity. A comparison of user accounts with multiple collisions may be executed to identify similar content as coordinated activity. A visualization tool constructs a network graph that shows relationships between users in social networks, and can be used to discover coordinated users engaged in misuse of social media.

### FIELD

The present invention relates to detecting coordinated activity on social media networks. More specifically, the invention relates to systems and methods for detecting coordinated actors engaged in misuse of social media by identifying user accounts exhibiting similar behaviors repeatedly over time.

### BACKGROUND

Social networking service providers facilitate creating, distributing, and exchanging social media between users in virtual communities called social networks. Service providers include, for example, FACEBOOK and TWITTER. These service providers offer interactive online portals that are accessible through client devices such as personal computers, tablets and smartphones. Depending on the social network, a user can register with a service provider, create a profile, add other users to her social networks, exchange social media, and receive notifications from the service provider. A user may join different social networks to share social media of common interest to a single user or an entire group of users in a particular social network.

There are many types of service providers. Some are focused on facilitating building personal networks based on friendships or social interests, such as FACEBOOK and TWITTER. Others are more focused on building professional relationships by connecting users with similar career interests, and allow users to market themselves in social networks, such as LINKEDIN. Other networks, such as YOUTUBE and FLICKR, are more directed to facilitating the sharing of multimedia, such as pictures, audio and video. However, the differences between social networks are becoming fewer as service providers continue to add additional functionality. Social media contributors may include individuals or organizations that support specific social causes or offer commercial products.

Organizations and individuals have begun to exploit the pervasiveness of social media by repeatedly sending undesired content to an ever expanding universe of recipients. Thus, users of social networks are increasingly being subjected to messages that are unreliable, unsolicited, or malicious. This is starting to make social media unappealing to users. Service providers have a particular interest in retaining users and maintaining their trust because their business models depend on keeping users engaged and satisfied with their experience.

Existing techniques for preventing the distribution of undesired and unsolicited electronic messages are inadequate for controlling the misuse of social media. Rules-based classifiers that use rules to categorize electronic messages based on their content have been used to detect spam in email. These classifiers may employ a learning feature to automatically generate rules based on text in incoming spam email that was not previously labeled as spam. However, rules make simple binary decisions about emails without identifying whether or not senders are engaged in a coordinated activity.

A social media information campaign refers to a process of gaining user traffic or attention through social media. Entities that organize these campaigns create social media that attracts attention from users and encourages them to share it with other users in their social networks. For example, messages can spread from user to user and resonate through multiple social networks because they appear to come from a trusted third-party source, as opposed to an entity that misuses social media. This type of activity is also known as “astroturfing” because it is a fake grassroots information campaign. The misuse of social media happens frequently for different reasons.

A bad actor can shape opinions about a certain subject by perpetuating biased messages through social media. In other words, the bad actor can effectively spread a rumor about something by using social media. The bad actor sends a message to other users in a common social network who then forward the message to other users in their social networks, and so on, to perpetuate that same message through multiple social networks. In this way, it appears as though all the users share the same opinion about the subject discussed in the message. Although the bad actor that sent the original message is untrustworthy, the message appears trustworthy because it reached users through trustworthy users.

Bad actors craft messages and their profiles to appear as though they are trustworthy sources. For example, a bad actor may mimic the profile of a known trustworthy source or create messages that appear unique rather than generated by robots. The bad actor is essentially trying to convince people that there is a larger groundswell of support for a particular opinion that they are espousing. A message that originated from a bad actor but spread merely by other users forwarding the messages is more readily detected because the message carries metadata that identifies its source. Once the source is identified as a bad actor by a user, the bad actor's account can be terminated by the service provider and its messages can be removed from social networks.

Unfortunately, in another more complex and common example, a single entity may control multiple user accounts that are operated to send similar messages through social media by appearing to be trusted sources. Unlike a single message sent through multiple users, multiple similar messages sent from multiple coordinated actors do not include obvious indicators that can be used to halt the spread of undesired information. Existing classifiers have no way of detecting an information campaign based on coordinated activity from multiple users.

Although some methods for detecting undesirable messages in social networks exist, they remain deficient. An article by Gao et al., titled “Detecting and Characterizing Social Spam,” describes tracking user behavior to identify users that might click on the same “like” buttons in Facebook to boost what public figures are being “liked.” However, this article does not consider message content or any types of content in social media except FACEBOOK “like” buttons. Thus, the disclosed detector is not applicable to any other type of social network except FACEBOOK because it has a “like” button.

### SUMMARY

Described herein are systems and methods for detecting coordinated actors engaged in misuse of social media. Users engaged in coordinated activities are accurately and automatically detected. Such a technique is relatively transparent to users, does not require training data, and eliminates any need to manually construct or update rules for classifying social media. The described systems and methods adapt to salient changes in content and tactics that evolve over time such that users can trust that they will not be subject to future undesired information campaigns.

Employing such a detection system empowers users to expand their social networks because it increases their confidence that coordinated actors are contained and prevented from launching information campaigns. In a broader sense, the described systems and methods maximize the benefits of social networks by enhancing the free flow of unbiased information.

In some embodiments, a method for preparing a dataset of uncommon features includes retrieving a dataset of social media messages stored in a memory. The social media messages are authored by users of social media services. A processor is used for extracting features from the social media messages. Each of the extracted features is associated with a user that authored a social media message including the extracted feature. The method determines that the extracted features are uncommon features when a count for each of the extracted features exceeds a first threshold and is less than a second threshold.

In some embodiments, the uncommon features are stored in a dataset of uncommon features, and an uncommon feature is removed from the dataset when another extracted feature is determined as an uncommon feature and a quantity of uncommon features stored in the dataset exceeds a third threshold. In some embodiments, the social media services include FACEBOOK or TWITTER.

In some embodiments, the social media messages are authored by users of two or more social media services and may be reformatted into a common format before features are extracted. In some embodiments, each of the extracted features is passed through a hashing algorithm to convert them into hash values.

In some embodiments, a method for detecting coordinated social media activity includes providing a dataset of uncommon features stored in a memory. A processor is used to determine a number of collisions for social media messages authored by users. Each collision is detected as an uncommon feature that is present in a message authored by each of the users. In some embodiments, the method compares user account information when their number of collisions exceeds a first threshold. In some embodiments, the method determines whether or not the users are coordinated when a degree of similarity between their account information exceeds a second threshold.

In some embodiments, user account information includes social media messages and user profile information. In some embodiments, a feature count is determined for each of the uncommon features. The feature count is incremented when an uncommon feature is detected in social media messages that are authored by multiple users. In some embodiments, an uncommon feature is removed from the dataset of uncommon features when a feature count for the uncommon feature exceeds a third threshold.

In some embodiments, a display visualizes a network graph that represents relationships between users. Nodes represent users and lines connecting nodes represent collisions between the users. In some embodiments, a histogram shows different degrees of similarity between user account information. In some embodiments, a hashing algorithm is applied on each detected collision to obtain a hash value.

In some embodiments, a method for visualizing users that are suspected of engaging in coordinated activity in social media includes a display for generating a network graph of users that are suspected of engaging in coordinated activity. Each node in the network graph represents a user and each line connecting nodes represents a quantity of features identified in social media messages that are authored by users represented by the nodes connected by each line.

In some embodiments, the method includes changing a threshold value of a degree of similarity between the users that are represented by the nodes. Increasing the threshold value decreases a quantity of nodes in the network graph, and decreasing the threshold value increases the quantity of nodes in the network graph. In some embodiments, users engaged in coordinated activity are identified based on a quantity of nodes and their connecting lines in the network graph, and the threshold value.

In some embodiments, a system for preparing a dataset of uncommon features includes a memory for storing a dataset of social media messages. The social media messages are authored by users of social media services. The system includes a processor for extracting features from the social media messages. Each of the extracted features is associated with a user that authored a social media message including the extracted feature. The processor is used for determining that the extracted features are uncommon features when a count for each of the extracted features exceeds a first threshold and is less than a second threshold.

In some embodiments, uncommon features are stored in a dataset, and an uncommon feature is removed from the dataset when a quantity of uncommon features stored in the dataset exceeds a third threshold. In some embodiments, the plurality of social media messages are authored by users of two or more social media services that are configured to communicate with the users over the Internet.

In some embodiments, a system for detecting coordinated social media activity includes a memory that stores a dataset of uncommon features stored in a memory. A processor is used for determining a number of collisions for social media messages authored by users. Each collision is detected as an uncommon feature from the uncommon features that is present in a message authored by each of the users.

In some embodiments, the processor is configured to compare account information of users when their number of collisions exceeds a first threshold. In some embodiments, the processor is configured to determine whether or not the users are coordinated when a degree of similarity between their account information exceeds a second threshold. In some embodiments, user account information includes social media messages and at least one of user profile information and metadata.

### BRIEF DESCRIPTION OF THE DRAWINGS

Exemplary embodiments of the invention will now be described with reference to the accompanying drawings, in which:

FIG. 1 is an illustration of a networked system according to embodiments of the invention;

FIG. 2 depicts a service provider system according to embodiments of the invention;

FIG. 3 illustrates a network graph of social networks according to embodiments of the invention;

FIG. 4 is a flowchart for a method of determining users engaged in coordinated activity in social networks according to embodiments of the invention;

FIG. 5 illustrates a detection system according to embodiments of the invention;

FIG. 6 is a flowchart for incrementing uncommon features to store in an inverted index, and updating the inverted index, according to embodiments of the invention;

FIG. 7 is a list of TWITTER tweet messages distributed by a user and generated by the visualization tool according to embodiments of the invention;

FIG. 8 is a screen shot of an “Upload” display screen with various datasets that can be selected for detection of coordinated activity according to embodiments of the invention;

FIG. 9 is a screen shot of a “Network Exploration” display screen of a user interface, at a point in the workflow where an administrator has selected a cluster of users and individual user for further inspection according to embodiments of the invention;

FIG. 10A is a histogram generated by a visualization tool, which shows a coordinated activity by user accounts that are 100% similar according to a set threshold according to embodiments of the invention;

FIG. 10B is a histogram generated by a visualization tool, which shows user accounts with different degrees of similarity according to a set threshold according to embodiments of the invention;

FIG. 10C is a histogram generated by a visualization tool, which shows user accounts with different degrees of similarity, set to a 0.3 threshold according to embodiments of the invention;

FIG. 11 is an illustration of a “Clusters” box that includes a number of circles, where each circle represents a group of similar users according to embodiments of the invention;

FIG. 12 is a “Network graph” generated by a visualization tool that includes nodes representing users of suspected coordinated activity according to embodiments of the invention;

FIG. 13 is a dropdown menu over the “Network graph” that can be used to annotate data associated with a user represented by a node according to embodiments of the invention; and

FIG. 14 is a screen shot of a “Filter” display screen generated by the visualization tool to enable an administrator to filter messages in a dataset according to embodiments of the invention.

To facilitate understanding, identical reference numerals have been used, where possible, to designate identical elements that are common to some of the figures.

### DETAILED DESCRIPTION

Existing systems fail to identify coordinated activity between users in social networks because they merely focus on identifying malicious or spam-like messages. They also fail to detect new information campaigns because they rely on common and known indicators of spam to identify incoming spam messages. In other words, existing systems detect known spam topics but fail to detect users engaged in coordinated activity.

Applying classifiers to social media would provide seriously deficient results because social media is fundamentally different than most electronic messages due to its frequency, immediacy, and ease of distribution to recipients in trusted groups. However, messages broadcast through social networks are quickly becoming a preferred method of communication for many individuals and organizations for these very reasons.

Unlike existing systems, the described systems and methods compare behavior between multiple users to determine if the users behave similarly, not exclusively based on the content of their messages. The described systems and methods accurately distinguish between legitimate users and coordinated users that appear legitimate. This eliminates an extremely complex, tedious, and time-consuming need to manually compare user accounts. This also prevents coordinated users from circumventing detection by changing messages over time or crafting messages from different users that appear slightly different from known indicators of malicious content.

Detecting coordinated activity in social networks and other informal online content systems is valuable for user retention, marketing, and legal investigation. Described herein are systems and methods that create and or utilize a dataset of uncommon features extracted from social media messages. This dataset of uncommon features may be referred to as a feature index. A message may be referred to as a communication distributed by a user over a network and may include any type of content, such as text, images, video, audio, and the like. The features are uncommon because they are rarely identified in messages. Embodiments use the uncommon features detected in messages to identify users engaged in coordinated activity. In some embodiments, this departs from existing detection methods that use training data comprising common features that are good indicators of malicious electronic messages.

The disclosed systems and methods may be applied to a dataset of social media messages from a population of users. The dataset may be a subset of messages, profile information and metadata, or combinations thereof. The messages are processed into a common format. The reformatted messages are searched for uncommon features contained across multiple messages authored by multiple users. The uncommon features are extracted from the messages and stored in the feature index.

The feature index, which is a set of uncommon features, may be constructed in a variety of ways. Typically, the accuracy of predicting coordinated activity varies based on the volume and types of uncommon features in the feature index. In some embodiments, the disclosed detection system can significantly outperform existing systems and methods by using uncommon features to find coordinated users, rather than just using common features in messages to identify individual malicious messages. Users that include the same uncommon features in their messages are said to collide.

A collision is an association between messages from two or more users and may indicate a relationship between these users. A distinct collision between the two or more users is detected when messages from the two or more users have the same uncommon feature. A number and/or frequency of collisions between users may be used to indicate a probability of coordinated activity.

The number and/or frequency of collisions may be used to decide whether or not to execute a comparison of user accounts, including social media messages, profile information and metadata. For example, users that have collided often may have their accounts compared to determine if they are actually a single entity masquerading as two or more users. User accounts with similar content are identified as being controlled by the same entity. That is, the detection system is said to have detected coordinated activity. The accounts of coordinated users may be suspended and/or their messages deleted or otherwise marked.

A visualization tool may be used to import data from the detector system to construct a network graph that shows relationships between users in social networks. Users may be visualized as nodes, and connectors between nodes represent collisions between users. A node may represent a suspected coordinated user. The network graph can be used to identify coordinated users engaged in misuse of social media. The visualization tool can also incorporate data from known groups of coordinated users to identify if suspected coordinated users have collided with the known coordinated users. Consequently, the known coordinated users and suspected coordinated users may be part of the same information campaign. The detection system can also use historical information with a new dataset of social media to enhance its ability to detect coordinated users that behave similar to known coordinated users.

The described systems and methods can be utilized in substantially any social media or electronic messaging systems to detect coordinated activity. In some embodiments, the systems and methods work across social media services by detecting coordinated users acting on a number of different social media networks in different services. The described systems and methods can be readily embodied as a stand-alone software program or integrated as a part of another program. The program may reside at a server or client computer, or combinations thereof. Different software program modules may reside at a client, server or across multiple computing resources in a network. Nevertheless, to simplify the following discussion and facilitate reader understanding, the description will discuss the detection system in the context of use within a software program that executes on a server to detect coordinated activity by users of social media.

### I. Computing Environment

The described systems and methods may be embodied as software programs stored on non-transitory computer readable mediums. The software programs can be executed by a CPU on a server. This server may be the same or different from servers operated by a social networking service provider, such as FACEBOOK or TWITTER. Accordingly, the service provider may police its users to identify users engaged in coordinated activity. In some embodiments, the software program resides in a server that remotely services social networking service providers. In these embodiments, a company may pay for services that aid to identify user accounts for termination by the company. In some embodiments, the system may be connected to a plurality of service providers to allow for the detection of coordinated users acting on a number of different social networking services.

Social media may be transmitted between users registered to a social networking service over a communications network, such as the Internet. Other communications technology for transmitting social media may include, but are not limited to, any combination of wired or wireless digital or analog communications channels, such as instant messaging (IM), short message service (SMS), multimedia messaging service (MMS) or a phone system (e.g., cellular, landline, or IP-based). These communications technologies can include Wi-Fi, BLUETOOTH and other wireless radio technologies.

Social media may be transmitted to a server operated by or for a social networking service provider. The social media may then be transmitted to recipient users in a social network associated with the user sending the social media. The social media may also be sent directly between client devices without passing through an intermediate server. In some embodiments, any client device can access output from the disclosed detector system by using a portal that is accessible over the Internet via a web browser.

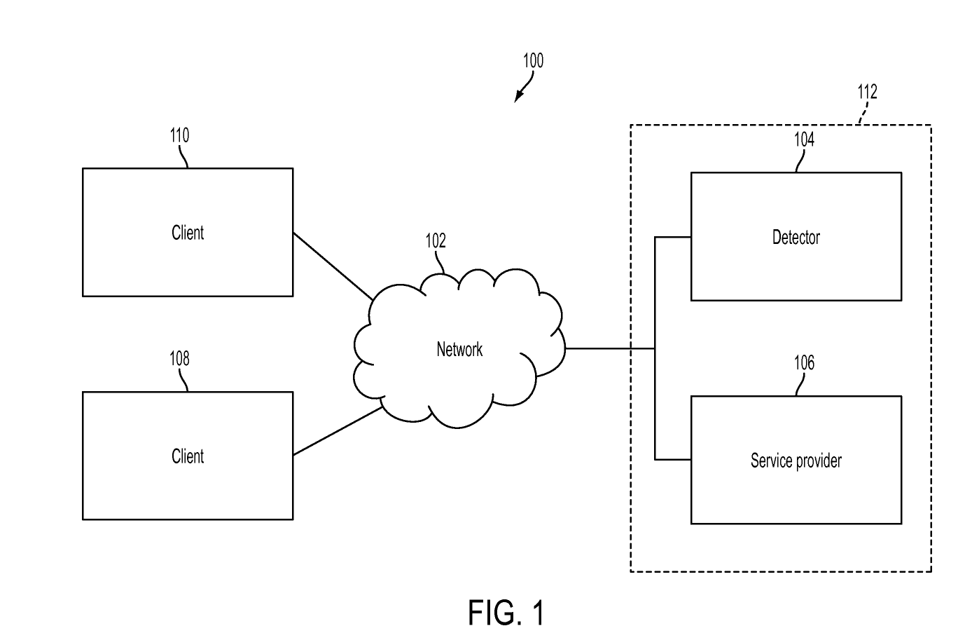

FIG. 1 depicts an embodiment of a system 100. The system includes client devices 108 and 110 that are configured to communicate with service provider 106 over network 102. System 100 includes detector 104 that is configured to communicate with service provider 106 or clients 108 or 110, or any combinations thereof. Detector 104 and service provider 106 may reside on a common server 112 or different servers. Detector 104, service provider 106, or clients 108 or 110 can be or can include computers running ANDROID, MICROSOFT WINDOWS, MAC OS, UNIX, LINUX or another operating system (OS) or platform.

Client 108 or 110 can be any communications device for sending and receiving social media messages, for example, a desktop or laptop computer, a smartphone, a wired or wireless machine, device, or combinations thereof. Client 108 or 110 can be any portable media device such as a digital camera, media player, or another portable media device. These devices may be configured to send and receive messages through a web browser, dedicated application, or other portal.

Client 108 or 110, service provider 106, or detector 104 may include a communications interface. A communication interface may allow a client to connect directly, or over a network, to another client, server or device. The network can include, for example, a local area network (LAN), a wide area network (WAN), or the Internet. In some embodiments, the client can be connected to another client, server, or device via a wireless interface.

As shown in FIG. 1, system 100 may comprise a server 112 operated by service provider 106 and detector 104 that analyzes social media received by service provider 106 from clients 108 and 110. In some embodiments, service provider 106 and detector 104 reside on different servers. Detector 104 may analyze social media before or after it is received by service provider 106 from clients 108 or 110. Embodiments of the described systems and methods may employ numerous distributed servers and clients to provide virtual communities that constitute social media networks. FIG. 1 shows only two clients for the sake of simplicity.

In some embodiments, parts of detector 104 may be distributed across several servers, clients, or combinations thereof. The server of detector 104 or service provider 106, or clients 108 or 110 may each include an input interface, processor, memory, communications interface, output interface, or combinations thereof, interconnected by a bus. The memory may include volatile and non-volatile storage. For example, memory storage may include read only memory (ROM) in a hard disk device (HDD), random access memory (RAM), a solid-state drive (SSD), and the like. The OS and application programs may be stored in ROM.

Specific software modules that implement embodiments of the described systems and methods may be incorporated in application programs on a server or client. The software may execute under control of an OS, as detailed above. When stored on a server of detector 104, embodiments of the described systems and methods can function and be maintained in a manner that is substantially, or totally, transparent to users of social networks.

As shown in FIG. 1, in one example, incoming social media from clients 108 or 110 is sent over communications network 102 (such as the Internet) or through another networked facility (such as an intranet) or from a dedicated input source, or combinations thereof. In some embodiments, social media can originate from a wide variety of sources, such as by devices with textual keyboards, a video feed, a scanner or other input source. Input interfaces are connected to paths and contain appropriate circuitry to provide electrical connections required to physically connect the input interface to a larger system and to different outputs. Under control of the OS, application programs that run on a client or server exchange commands and data with external sources, via a network connection or paths to transmit and receive information from a user during execution of detector 104 or service provider 106.

The server 112, or clients 108 or 110, may also be connected to input devices, such as a keyboard or mouse. A display, such as a conventional color monitor, and printer, such as a conventional laser printer, are connected via leads and, respectively, to output interfaces. The output interfaces provide requisite circuitry to electrically connect and interface the display and printer to the computer system.

Through these input and output devices, a user can instruct service provider 106 to transmit social media and instruct client 108 or 110 to display social media. In addition, by manipulating an input device, such as by dragging and dropping a desired picture into an input field of a social media portal displayed at client 108 or 110, a user can move the picture to the server operated by service provider 106, as described above, and then service provider 106 can broadcast the picture to clients 108 or 110 that are operated by users of a social network.

Detector 104 may be embodied in a product that a social media provider, for example TWITTER, can install on its platform. Detector 104 can analyze social media on a recurring schedule, such as a previous day's TWITTER tweets or a previous day's trending topics or something similar, for example. Then, after using detector 104, suspected coordinated users could be marked for removal from service provider 106.

Detector 104 could be embodied as a JAVA tool, which means it can run on any platform that is JAVA enabled. Embodiments of detector 104 can run on a web server that provides a website for administrators to access detector 104 remotely over network 102. Anyone with administrative access to the web server can connect to and use visualization tools provided by detector 104 to take actions within a visualization. Detector 104 can run on any type of server, including virtual servers or an actual machine. Detector 104 can be designed to operate in any computing environment because it has very few requirements for underlying hardware and operating systems.

Detector 104 may be embodied on a distributed processing system to break processing apart into smaller jobs that can be executed by different processors in parallel. The results of the parallel processing could then be combined once completed. Features of detector 104 can be provided to service provider 106 as a subscribed service.

### II. Social Media

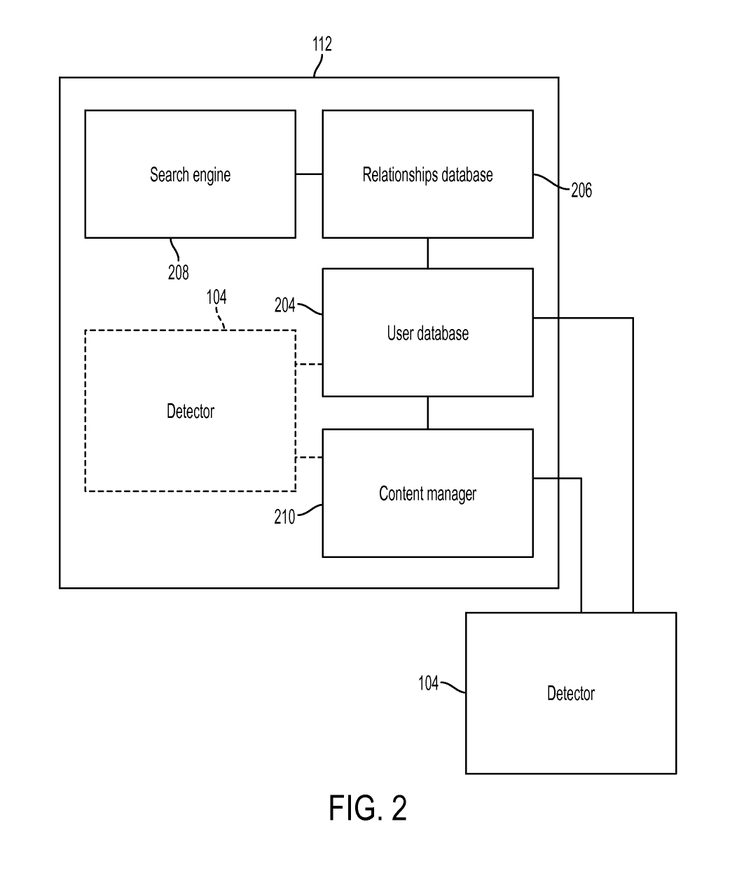

FIG. 2 depicts a service provider 106 that may be executed by server 112. In some embodiments, service provider 106 may be implemented in an array of servers. Server 112 provides an interactive portal that is accessible by users operating client devices 108 or 110 over network 102 to share social media in social networks. Server 112 may manage user database 204, relationships database 206, search engine 208, social media content manager 210, and detector 104.

FIG. 2 shows detector 104 communicating with user database 204 and content manager 210. Detector 104 may be external and remote from server 112 as shown by the solid black lines, or detector 104 may be a part of server 112 as shown by the broken black lines.

Users of social networking services, such as FACEBOOK and TWITTER, define their own social networks to share social media. Users tend to be attracted to the ease of sharing information on an informal basis in their social networks. The pervasiveness of social media has resulted in voluminous amounts of content distributed between and across social networks. In turn, this has sparked a great deal of interest from advertisers and other entities who seek to exploit the pervasiveness of social media. This includes entities who seek to abuse social networks for their own purposes.

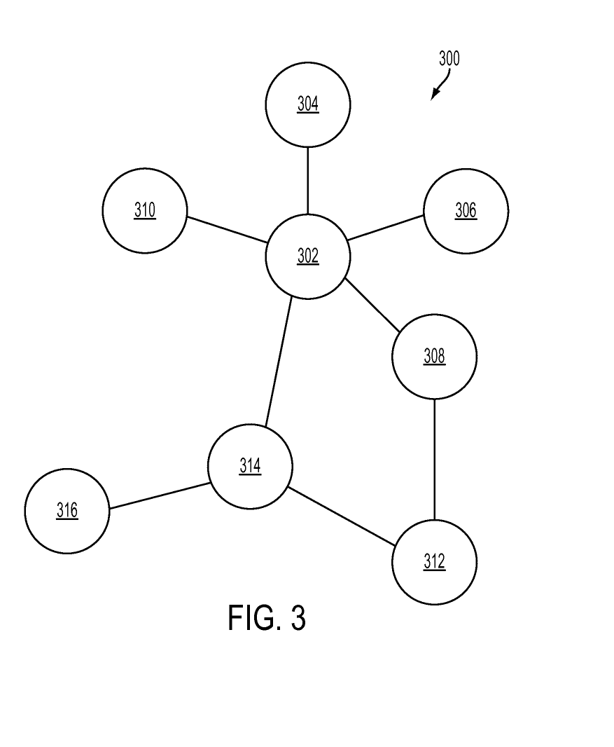

FIG. 3 illustrates a network graph of social networks. That is, social networks may be represented using a graph structure. Each node 302 through 316 of graph 300 corresponds to a user of the social network. Connectors between nodes represent a relationship between two users. For example, user nodes 302, 304, 306, 308 and 310 are one social network. User nodes 302, 312, 314 and 316 are another social network, for example, and so on.

The degree of separation between any two nodes may be defined by a number of connectors required to traverse graph 300 between two nodes. A degree of separation between two users is a measure of relatedness between them. For example, user nodes 302 and 304 are directed related, whereas user nodes 304 and 316 are related by three degrees of separation, between user nodes 302 and 314. A social network may be extended to include nodes to an Nth degree of separation. The number of nodes typically grows at a dramatic rate as the number of degrees increases.

User nodes 302 through 316 create, exchange, or share social media. The users access service provider 106 through client device 108 or 110, which may be embodied as a smartphone or laptop computer. Client device 108 or 110 provides web portals or dedicated applications to access an interactive platform, to share social media with their social networks. Users login to a social media portal by manually entering a username and password, or automatically with user identification information stored on client devices 108 or 110. The interactive platform allows users to participate in social media communications with social networks over network 102. For example, a social media portal may include text fields, voice recognition or video-capture functions to receive multimedia content. A user inputs social media content by using hardware of client device 108 or 110, such as a touchscreen on a smartphone or tablet computer. Client device 108 or 110 then transmits content to users operating other clients in the same social networks.

### 1. User Database

User database 204 includes information about registered users. An individual registers as a user by accessing service provider 106 over network 102 to provide identifying information. The identifying information may include an email address that enables the user to become a registered user. Each user then creates a profile. The user database 204 contains profile information for each user. The profile information may include a unique identifier, name, age, gender, location, hometown, images, interests, attributes and the like.

### 2. Relationships

Relationships database 206 may store information about relationships between users represented by nodes 302 through 316. The relationships among groups of users define a social network. The types of relationships may range from casual acquaintances to close familial bonds. In some embodiments, a user can establish a relationship with another user by sending her a message to request the relationship. The recipient of a relationship request message may be able to review the sender's profile information to decide whether or not to become part of the sender's social network or decline the request. The recipient can decide to designate the type of relationship. For example, a recipient can accept the request and identify the sender as a classmate. Accepting a request to associate with a user may establish bidirectional communications between users to exchange social media content.

In some embodiments, a user may establish a relationship with other users without approval by the recipient user. This may be referred to as “following” a user or content source. Following a user establishes unidirectional communication between users, where a user can view social media content distributed by a content source, but the content source does not receive social media broadcast by the recipient user. Thus, social media is not exchanged between users in a unidirectional relationship. In some embodiments, a user can just join a social network that includes many users, but the user does not necessarily choose each member of that social network. In some embodiments, a user that follows one content source may follow all of the content source's followers. The user database 204 and relationships database 206 are updated to reflect new user information and edits to existing user information that are made through client device 108 or 110.

### 3. Searching

Search engine 208 may, for example, identify users, for joining them in a particular social network. A user can identify other users by searching profile information stored in user database 204. For example, the user can search for other users with similar interests listed on their profiles. In this manner, social networks can be established based on common interests or other common factors. Search engine 208 can be used by service provider 106 to identify and recommend relationships to users.

### 4. Management

Content manager 210 may provide a free flow of social media between users of social networks, represented by nodes 302 through 316. Social media may be distributed by a user of a social network to other users of their immediate social network. Social media messages may include text, still images, video, audio, or any other form of multimedia or electronic data. For example, a user can compose a message by using a client device 108 or 110 that accesses server 112 of service provider 106 over network 102. The message is uploaded to server 112 by the user. Server 112 can then send the message to social networks that have the sending user in common. For example, a message from user node 314 may get distributed to user nodes 316 and 312. Users of the social networks may receive and can review the message on client devices 108 and 110. In this manner, users of a social network can become apprised of information posted by other users of the same social network. Content manager 210 can also operate to store social media content.

A message can be sent from user node 314, who is operating client device 108, to user nodes 302, 316 and 312 at multiple endpoints client devices. For example, suppose a user sends a message from her smartphone. This message can be received by a user in the same social network through a communications channel and on a personal computer client device. Another user in the same social network may receive the same message at his tablet computer. The endpoint clients at which particular users receive social media are under control of the receiving users and are not of concern to the sending user. Service provider 106 beneficially allows a user from any client device to send a message to multiple users at different endpoint client devices by simply addressing the message to a social network, without knowledge of specific endpoint clients devices associated with users in the social network.

### III. Managing Misuse of Social Media

Users of social networks expect to and regularly receive social media from other users in the same social networks. Sometimes users choose all the users of their social networks; sometimes they choose only categories of users or choose only some of the users of their networks. Users seek to establish relationships with trustworthy users that may provide honest or useful content of interest. An assessment of trustworthiness is subjective because users typically base their decision to create a new relationship on profile information that was created by a user of unknown trustworthiness. Users also assess trustworthiness of a user based on a degree of relatedness between the user and a known trustworthy user. In other words, users tend to infer trustworthiness based on profile information and related relationships.

A user may also use search engine 208 of a social media portal to search for keywords, images, or familiar features in profile information or user group information to identify users of common interest. The user can infer trustworthiness if a user of unknown trustworthiness appears similar to or related to a trustworthy user. For example, a user at node 302 may accept a request to establish a relationship with an unknown user at node 316 because the user at node 302 believes that the user at node 314 is trustworthy. Consequently, a user may unknowingly establish a relationship with a coordinated user that is masquerading as a trustworthy user.

Social media users that coordinate their messages, for example, as part of an information campaign, may be referred to as coordinated users. Many times, coordinate users are a single person, group of people, or entity that creates multiple user accounts to imitate different unrelated users. Coordinated users may violate the terms of service of a social networking service provider. Coordinated users may also violate the trust of users who are expecting to receive content from trustworthy users. Coordinated users may lure users to establish a relationship by creating a profile and distributing content that suggests that it is a legitimate and trustworthy user. Coordinated users may create profiles that use colors, images, and keywords that are indicative of trustworthy social interest groups.

Coordinated users may masquerade as trustworthy users by using similar profile information and content that is used by known trustworthy users. Coordinated users engaged in coordinated activity can thus barrage users with biased information. The cumulative effect of coordinated activity is to bias an opinion about a subject, or bias users or eventually lead them to provide personal information that can be abused. This type of information campaign remains elusive to existing systems.

For example, coordinated users may create profiles including an icon with the same white image over a blue background, and which uses keywords to suggest an affiliation with a well-known group. The coordinated users may then distribute content that is meant to bias recipient users. Coordinated users may choose or change the content of their messages to circumvent existing systems by not providing obvious and/or common indicators to users about their coordination and intent. In addition, a single entity controls multiple coordinated users to give the appearance that the information distributed is trustworthy because multiple users are distributing the same information. Thus, coordinated users remain elusive to existing detection systems.

Users can easily receive hundreds of social media messages over a few hours or less. Coordinated users included in several networks can broadcast a large amount of social media messages over a short period of time. Given the pervasiveness of social media, messages can be readily disseminated across an extremely large number of social networks.

The integrity of a social networking service is compromised as the number of coordinated users increase. In particular, users lose interest in a social media when content is biased, duplicative, redundant or not authentic. Accordingly, advertisers lose interest in paying for ads in social media when an audience of users is decreasing. Consequently, social media companies lose revenue as social media loses its appeal to users.

Information campaigns may be used to misuse social media by using coordinated users of a social network to provide similar information to recipients of that information. The users think that the same opinions are shared by different unrelated users. Although information campaigns operated by coordinated users may be benign, such as news about celebrities, other information may include inflammatory or abusive material that is highly offensive. Information campaigns resulting from coordinated activity may be used to target groups of users. In other words, information campaigns may be directed at biasing the content received by users of a social network. All such social media may collectively constitute a coordinated information campaign. This occurs without awareness by recipients because the coordinated users are masquerading as trustworthy users to the deceived recipients.

Information campaigns may also be used to mislead analytics companies that use social media to measure an opinion that people have about particular subjects or products. For example, an analytics company may have a soft drink company as a client. The soft drink company may want to know how people feel about a new product. The analytics company may analyze TWITTER feeds to conclude that people dislike the new product. However, a competitor may be controlling many TWITTER accounts that generate messages stating that the new product is not good.

Once a user of a social network establishes a relationship with a coordinated user that is part of a coordinated information campaign, that individual user may not readily, if at all, distinguish between a trustworthy user and coordinated users. This means that the user may continue to receive undesired content, often in increasing amounts from multiple coordinated users that are engaged in an information campaign. This occurs simply because the coordinated users prevent other users from identifying their relationship.

A user may be a target of multiple coordinated users engaged in coordinated activity to barrage the user with false or misleading social media. A coordinated user that originally deceived the user to join a social network may then disseminate the user's profile information to other coordinated users in an effort to establish relationships between the deceived user and other related coordinated users. The user is then barraged with social media that may be intended to bias the user and this perpetuates information that is used to extract personal information, to lead the user to malicious websites, to convince user to adopt a certain opinion, or bias what analytics companies conclude about social opinions. Consequently, over time, users often find themselves flooded by malicious information campaigns. A targeted user may be added to a list comprising a group of targeted users with common interests. The list may be maintained by a wide and increasing variety of coordinated users.

Detecting coordinated users in social networks has typically relied on a subjective analysis of profile information and content distributed by the suspected coordinated users. Many features in user profiles and content are markers of coordinated users. For example, a service provider may identify coordinated users when they distribute duplicative messages. Thus, coordinated users may be removed from social networks if a service provider subjectively identifies the coordinated users based on content or profile information. Mutual cooperation between users and a service provider may facilitate removing coordinated users from social networks by encouraging users to identify and report suspicious users to the service provider. However, identifying coordinated users is increasingly difficult because they use profile information that mimics profiles of trustworthy users. For example, several TWITTER user icons may appear similar, such that it is virtually impossible to identify if any of these users is a coordinated user by merely glancing at the TWITTER user icons.

### IV. Detecting Coordinated Users

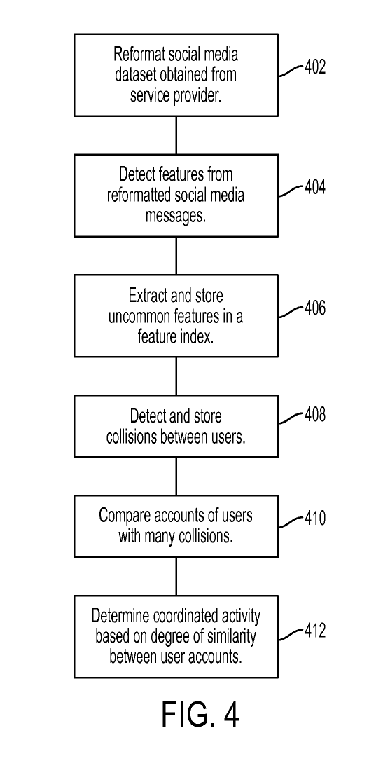

It has been found that coordinated users can be detected in a variety of methods. FIG. 4 is a flowchart of a method of determining users engaged in coordinated activity in social networks. First, social media distributed through a social networking service provider is analyzed to determine if the social media is part of an information campaign. A dataset of social media messages from a service provider may be reformatted at step 402. Features in the reformatted social media are detected in step 404. The features are analyzed to identify uncommon features, and the uncommon features are stored in a feature index according to step 406. A “collision” between two or more users is detected and stored, according to step 408, as the same uncommon feature in different messages authored by each of the two or more users. An in-depth analysis is conducted of user accounts for users that have collided often, for example over a threshold amount, according to step 410. Users with content and behavioral characteristics that are very similar are then identified as coordinated users, according to step 412.

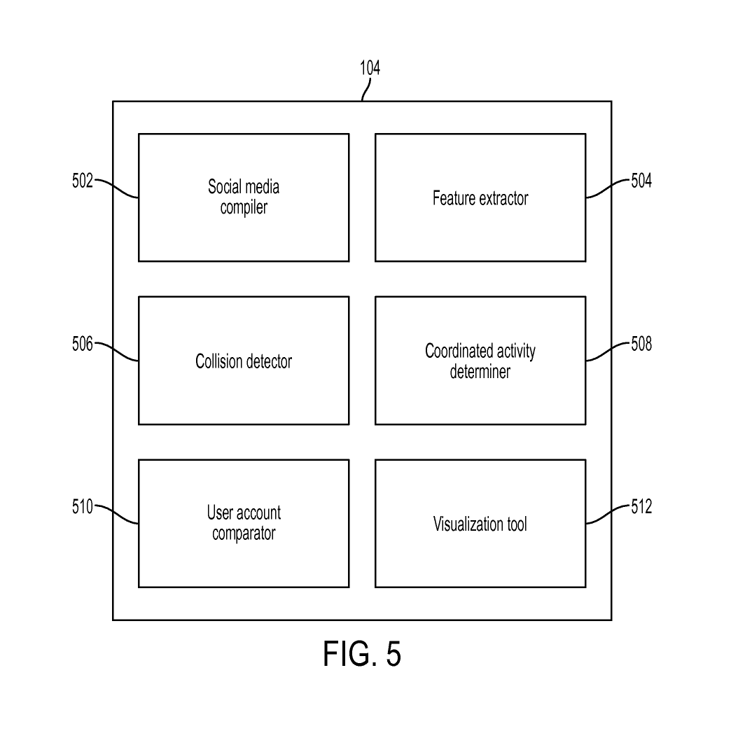

The detection methods may be implemented using detector 104. Detector 104 may detect whether a single entity is masquerading as multiple users to flood social media with content that is biased, as part of an information campaign. FIG. 5 illustrates a detection system according to embodiments of the invention. Detector 104 includes social media compiler 502, feature extractor 504, collision detector 506, coordinated activity determiner 508, user account comparator 510, and visualization tool 512. These items are discussed in detail below.

Detector 104 can be used alongside social media analytics operated by companies. Analytics companies engaged in analyzing social media, to determine the sentiment of a particular subject, can use detector 104 to exclude social media that is biasing a sentiment analysis. For example, every message that mentions a subject of interest is identified and flagged by detector 104. The flagged messages are analyzed to identify users engaged in coordinated misuse of social media. The coordinated users are removed from the analysis to determine an accurate sentiment of the subject of interest.

In the example provided above, an analytics company may have a soft drink company as a client. The soft drink company may want to know how people feel about a new product. However, a competitor may be controlling hundreds of TWITTER accounts that generate millions of tweets stating that the product is not good. Detector 104 can identify and remove the hundreds of TWITTER accounts controlled by the competitor. Removing these fake accounts from a sentiment analysis may actually result in the opposite conclusion. That is, the analytics company may conclude that people enjoy the new product.

### 1. Dataset of Social Media

A sample dataset of social media must be input into detector 104 to identify coordinated users. The sample dataset may include messages that are periodically retrieved from social media sent over network 102 from clients 108 or 110 through service provider 106. The dataset may represent a subset of social media sent to service provider 106. In some embodiments, the social media is from different users and filtered for particular factors. For example, social media from users at particular locations or generated at particular times may be compiled into a dataset. The extracted social media can be messages on the same or different topics with content that varies in degrees of similarity. The content can be collected from a real-time stream of social media passing between client devices over the Internet. In some embodiments, the messages are collected at designated times of the day.

In some embodiments, the data may be collected in a desirable format. In other embodiments, detector 104 may reformat the data. In some embodiments, collections of social media data may be acquired from companies that collect and package these feeds. For example, social media data may be purchased from data companies that include GNIP, TOPSY and DATASIFT. Data companies purchase rights to social media output by service providers, like FACEBOOK and TWITTER. The rights may include every message output by a service provider. The data companies may resell portions of their data to customers, or sell a streaming service to connect and download social media in real-time. Embodiments of detector 104 may receive reformatted social media messages from a data company. For the sake of simplicity, this disclosure describes reformatting collected social media at detector 104.

In some embodiments, detector 104 includes social media compiler 602, which enhances and otherwise modifies collected social media to conform to a standard format. Many suitable formats exist, such as JSON, for example. Although the particulars of a format may vary from service to service, an appropriate format is incumbent on metadata that lets other parts of detector 104 know which part of a message is its body, the time the message was created, the author of the message, account identification and the like.

### 2. Extracting Features

Messages in a desired format can be uploaded to feature extractor 504 in a variety of ways. For example, the messages may be inputted through an automated process or manually by a user. FIG. 8 shows various datasets that can be selected by a user to process by feature extractor 504 to detect coordinated activity. The quantity and type of formatted messages that are input for analysis by feature extractor 604 may vary according to different needs. A batch of messages may be processed when an administrator that operates detector 104 issues a command such as “process these messages.” For example, 100,000 INSTAGRAM pictures, a million FACEBOOK posts, and 5 million TWITTER tweets may be collected, reformatted into a uniform format, and inputted for analysis to determine whether or not messages are masquerading like similar opinions from different users when, in actuality, the opinions in the messages are controlled by a single entity.

After reformatted messages are received and inputted, the messages may be parsed into different data types. In some embodiments, all the data types are extracted from each message and categorized for subsequent analysis. In other embodiments, only selected data types are extracted for subsequent analysis. Data types selected for extraction may be of a particular interest depending on the type of analysis desired. Thus, the type of data extracted can vary depending on need, from case to case. The selection of data types may also be automated or based on a user decision. Overall, feature extractor 504 extracts data from messages in the reformatted dataset to identify uncommon features that indicate coordinated activity.

Detector 104 can detect various indicators in social media to determine coordinated activity. These indicators are referred to herein as “features.” Features are potentially discriminative data in social media about user behavior that can be used to detect coordinated activity. Features may include text, video, sound, or images that are distributed by different users. Features also include metadata, such as timestamps when messages were sent, source locations or user identification information. Features may indicate that a message is related to another message that originated from a single source. However, features may not be explicitly apparent to readily detect coordinated activity. For example, multiple coordinated users may not share any social networks such that they do not provide any outward demonstration that they are working together.

Social media includes many sources of potentially discriminative data that can correspond to features. Features may include the content of a text field in a message, as well as the content of fields in a corresponding user profile. A field is a part of a record that represents an item of data. This may include name, location and description fields in a profile. The content of fields in messages may vary considerably between users, and the content of fields in a profile may vary because a user can change any part of her profile at any time. Feature extractor 504 may sample features at different times. The features include different values in different fields between multiple users or the same user. A user that leaves blank profile fields such as name, description, or the like, may correspond to an empty set of features.

Features in a social media message may include an amount, type and combination of text, characters, images, icons, colors, and the like. Features may also include metadata such as timestamps, locations, profile information, and the like. Every social media message potentially has a vast number of features. Feature extractor 504 may use any subset of features from each message as part of the process to identify coordinated activity, according to FIG. 5. For the sake of simplicity, this disclosure focuses on textual features in social media messages.

In general, features used by detector 104 may be quite simple. Both word and character-level n-grams from different fields in messages may be included as features. An n-gram is a sequence of n items from a given sequence. The items can be words, characters, phonemes, syllables, or the like. In some embodiments, different types of features may include combinations of word or character n-grams, or time-based features.

In some embodiments, word n-grams are of a size 1 to 10, 2 to 200, or more preferably from 1 to 5. An n-amount of words is extracted from text of a message, or free-text metadata associated with each message, such as a user's description field in TWITTER. In the most basic form, the system receives and inputs each message. The text included in the messages may be broken down into an n-gram. For example, a trigram is a series of three consecutive words that may be in the body of a message. The n-gram could be thought of as a moving window that slides across a sentence and picks-out every n-word groups in that sentence. In other embodiments, the extracted features may correspond to data in other parts of a message.

In some embodiments, character n-grams are of a size 1 to 100, 10 to 1000, or more preferably from 3 to 15. An n-amount of characters is extracted from text of a message or metadata associated with the message including, on TWITTER, the user's screen name, display name, self-description, location, external URL, profile colors, user ID, and the name of the application that generated the message.

In some embodiments, time-based features may be used, in which feature extractor 504 divides a calendar into discrete blocks of time, and produces a feature for each pair of time-blocks in which users create messages. In some embodiments, feature extractor 504 divides a calendar into discrete blocks of time, and produces a feature for the time-block in which a user's account was initially created.

Each feature may be a simple Boolean indicator representing presence or absence of a word or character n-gram in a set of text strings within a particular field of a message. There are ultimately many ways to define features.

A user may define the types of features that will be extracted from messages. Feature extractor 504 then extracts features from each of the subset of collected and reformatted messages in a dataset. The extracted features may be temporarily stored in memory.

In some embodiments, a feature type may be defined as a word n-gram that separates words into groups of n-words, or may be defined to breakup words at transitions between alphanumeric characters and non-alphanumeric characters. Feature extractor 504 does not have to tokenize un-segmented languages such as Chinese, nor does it have to perform morphological analysis on a language, such as Korean. For example, extracted character-level n-grams provide useful information regardless of languages. Although feature extractor 504 may not use language-specific processing, some embodiments may benefit by using language-specific processing.

Feature types may be very specific, such as particular keywords. In some embodiments, a particular topic that circulates through social media can be analyzed by conducting a specific keyword search for words that are related to the topic. The words may be used to emulate an individual who is interested in studying a given topic. There is no requirement in how to select keywords other than selecting keywords that are of interest for analysis. Selecting keywords that are relevant to a particular subject of interest may improve the results obtained from detector 104 depending on what dataset is selected for analysis. A detection system that selects features by randomly sampling types of features from different messages may be less likely to find a tested behavior.

Ideally, feature types correspond to data that a customer wants to analyze for some other purpose. For example, a company may be interested in checking how much of a particular type of data is being circulated in random samples, or because the company is analyzing a dataset and wants to make sure that deceptive messages are not being included in the analysis.

### 3. Uncommon Features

Feature extractor 504 builds a dataset based on uncommon features identified in the dataset of social media messages, and records a list of users and the uncommon features exhibited by each user. This list is then used to create a dataset known as an inverted index, which lists each uncommon feature along with a list of users who exhibit that feature.

Uncommon features can be thought of as watermarks that are used to detect coordinated activity, and can be referred to as rare features. These features are so uncommon that they occur infrequently within a sample dataset. Uncommon features are potentially indicative of an author of a message. In a trigram, for example, three words that are uncommonly grouped but appear in messages from different users constitute uncommon features. Any number of words or any variation in their relative positions to one another can constitute an uncommon feature if they are uncommon and identified in messages from different users. Uncommon features could also be a string of characters, which may be particularly useful for analyzing languages that do not use boundaries in the same way as the English language. For example, the Chinese language does not have spaces between words.

Other uncommon features may be useful for indicating the author of a message. The string of characters that comprise a username associated with a message may also indicate an author. For example, the same string of five or ten characters may be extracted from name fields in different profiles.

Uncommon features occur so infrequently that the fact that multiple users include them in messages is an indicator that the messages are from the same author. In other words, this is an indicator that users are part of a coordinated activity.

### 4. Counting Uncommon Features

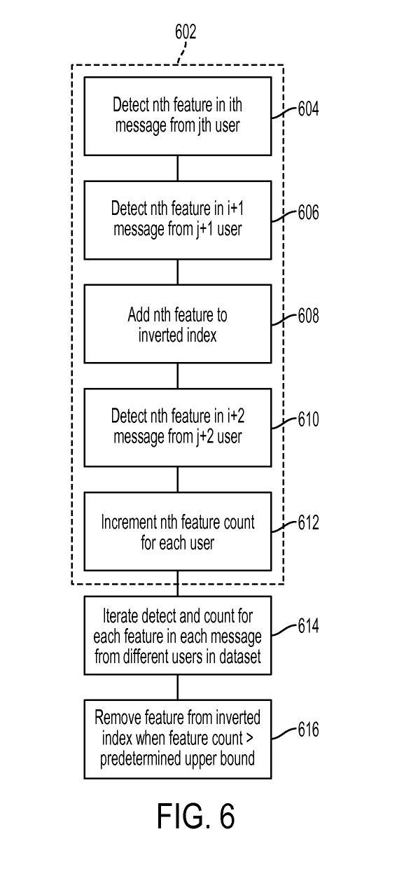

Uncommon features are extracted from messages, and the list of users exhibiting each feature is retained by detector 104 in the inverted index. FIG. 6 is a flowchart for incrementing uncommon features to store in an inverted index, and updating the inverted index. In step 604, feature extractor 504 detects an nth feature in an ith message from a jth user. Feature extractor 504 then detects the same nth feature in an i+1 message from j+1 user, according to step 606. The nth feature may then be added to an inverted index because it has been counted twice at step 608. The inverted index is a database for maintaining the uncommon features used to analyze messages. In step 610, the feature extractor 504 detects the same nth feature in i+2 message from j+2 user. The count for the nth feature is then incremented by 1, according to step 612. Then, in step 614, the detection and counting steps of 602 are iterated for each message from different users in the dataset. Any feature that has been counted greater than a predetermined threshold may be removed because the feature ceases to be uncommon, according to step 616. Details for each of these steps are provided below.

Feature extractor 504 may use a hash function to convert features into compact numerical values that can be stored and compared more efficiently. A hash function is any algorithm that maps data of variable length to data of a fixed length called a hash value. Data input can be a string of characters, words, numbers, any combination thereof, or the like. In particular, at its root, every piece of data is a series of bytes and a hash function takes the series of bytes and reduces it to a smaller series of bytes. This increases the efficiency of detecting uncommon features.

For example, each feature extracted in 604 may be a string of characters, and a hashing algorithm may reduce the string to 8 bytes. This is regardless of whether or not it is an entire book of text or a number between 1 and 100. The hash algorithm will map one piece of data to a number within a predefined range. A good choice of a hash function produces seemingly randomized outputs, but uses a deterministic process to make those “random” outputs repeatable. For example, MURMUR 3, JENKINS, SPOOKY or any non-cryptographic hash function may be used. A hash function built into JAVA could be used as well.

In some embodiments, detector 104 uses a noisy algorithm to improve memory efficiency. An exact count of each uncommon feature may not be determined because the feature is hashed. Thus, a count is determined within a certain error range. This increases memory efficiency but still allows for determining a number of times that uncommon features have been detected.

A count for each feature is stored in an inverted index when the count is within some predetermined range that can be set by using thresholds. This can prevent the inverted index from requiring more processing power or memory storage as an increasing number of uncommon features are detected in messages. In particular, thresholds may be used to determine when to store an uncommon feature in the inverted index and when to remove an uncommon feature from an index.

Features with counts that are below a threshold (lower bound) may be ignored because they are too uncommon to be part of coordinated activity. For example, a lower bound threshold for a feature count may be two or three, as shown in steps 606 and 608 of FIG. 6. Features that are identified so infrequently are not part of an information campaign because they are not related to any other messages in a campaign. Features with counts that exceed another threshold (upper bound) may be ignored because they are actually common features, as shown in step 616 of FIG. 6.

In addition, a total number of uncommon features stored on the inverted index may be limited to a maximum value. Thus, in some embodiments, new features are added to the inverted index only after other features drop out. For example, there may be 1,000 uncommon features stored on an inverted index. The features with higher counts that are below an upper bound threshold may be removed from the inverted index for new features that are detected with higher counts than a lower bound. Other embodiments can execute random dropouts of uncommon features from the inverted index when the number of stored features becomes too large. Features that drop out of the list may be stored on another list to indicate that those features are no longer of interest, or may be reintroduced later into the inverted index. An administrator may also selectively remove uncommon features from the inverted index that are subjectively determined to be benign.

For example, a feature corresponding to a particular trigram of words may be stored when it has been detected between 2 and 256 times in messages from different users. Step 608 of FIG. 6 shows that the nth feature is added to the inverted index because it has been detected once in different messages (twice in total) from different users, for example. The nth feature count is incremented each time the hash value is identified in another message, as shown in step 612 of FIG. 6. The algorithm thus allows for a noisy but memory-efficient count of numerous uncommon features.

In some embodiments, the noisy count may be conducted through a data structure called a “Count-Min Sketch.” This combines a series of hashing functions and a number of different counters. The output is combined to set a lower bound on how few times an event occurs. For example, a number of different arrays of counters may be kept and updated every time a particular feature is detected. The feature may be a long string of characters. Keeping a count for every possible string value quickly becomes unwieldy and overburdens any storage resources because the number of counters grows uncontrollably. Instead, hash values are tracked and the counter for that hash value is incremented when the hash value is determined. Multiple string values will hash to the same counter in that array, which is why this is executed several times with different counting arrays and with different hash functions each time.

Unlike existing techniques that use an accumulation of common features in training data as predetermined indicators of spam, detector 104 may rely on uncommon features that are not known beforehand. However, a training set of features can be used in some embodiments to modify the types of features searched for in messages. Some embodiments count features and then iterate over the feature data again later, or a streaming version is used to keep track of which current features will remain in the inverted index.

### 5. Collisions

Collision detector 506 of FIG. 5 detects and stores user information associated with uncommon features. A collision is generated between two or more user accounts that share an uncommon feature. The number of collisions between users is counted in a similar way that features are counted, as detailed above. This counting technique may be noisy to optimize the use of processing and storage resources.

Thresholds may be used to limit when collisions are counted, in a similar way that thresholds are used to limit the number of features stored in an inverted index, as detailed above. For example, collisions between users that happen only once may not be counted. Using thresholds optimizes the use of processing and storage resources because counting is computationally more expensive than just determining whether or not a feature or collision is detected.

Collisions are stored as a data structure by detector 104 in a database or an in-memory Count-Min Sketch. A counter increments each time two or more users collide on a single feature. Thus, the data structure records the total number of times that each of the two or more users has exhibited the same uncommon features.

For example, three words pulled from a message may correspond to an uncommon feature. Collisions are counted as the number of times that this uncommon feature appears in messages from different users. The collision itself passes through a hash function to generate a numerical value that defines the collision between two or more users, in a similar way that features are converted to hash values, as detailed above. The specific counter for a collision is incremented every time the collision is detected between the same users for the same or different uncommon features.

In some embodiments, a whitelist of users who have not collided, and are therefore not suspicious, can be maintained to prevent from iterating to check for uncommon features over these users. Users can be kept on the whitelist for a period of time and then reintroduced into the analysis.

Hash functions are also used to optimize use of storage. For example, inputting the collision Alan/John into a hash function will output a particular hash value, but the collision Alan/Johnny will output a different hash value. This hash function is repeatable because the same hash values are output for the same collision inputs into the hash function. Other types of algorithms may be used instead of a hash function, without altering the way embodiments of the described systems and methods operate. However, in some embodiments, different inputs should not generate the same outputs because this will mistakenly count a collision that does not exist.

In some embodiments, a hash value is divided by a number of counters and the remainder is extracted as the value for determining if a collision occurred. The part of the remainder used for the analysis depends on an amount required to ensure that values are properly categorized together only when they are the same. Some amount of overlapping between hash values is unavoidable because an enormous number of collisions may be counted with only a finite number of counters. However, the counting should be evenly distributed over the number of counters.

A bloom filter and the Count-Min sketch algorithm may be used to determine whether a collision has been previously detected. It also introduces some error that can be tuned to minimize false positives, but which would increase the use of computational and storage resources. This data structure thus maintains a noisy count of how many times each group of two or more users have collided.

In particular, the bloom filter may be used when deciding whether or not to begin counting collisions. Any other data structure that outputs a binary value could be used to make comparisons. A bloom filter or any other compact algorithm is preferred to function with a limited amount of computational requirements.

Thus, collisions are generated for each feature that is shared by two users. Then a bloom filter is used on the list of collisions to determine whether or not the collision has been encountered before. Each collision on the list is passed through the bloom filter. The bloom filter moves down the list to analyze all the collisions encountered for each feature. New collisions may be simultaneously added to the inverted index. When the bloom filter detects that a collision between two users has been encountered before for a different feature, the counter for that collision is incremented to reflect the number of collisions between the users. This process iterates over features analyzed in messages and increments when a collision for an uncommon feature is detected between the same users.

The process continues by going through the list of uncommon features on the inverted index, and by adding slightly noisy counts of how many times each group of two or more users collide. In one embodiment, coordinated activity determiner 508 uses these counts to determine when users are engaged in coordinated activity. A threshold may be used to decide a minimum number of collisions that constitute coordinated activity. For example, two or more users that have collided over 1,000 times can be designated as coordinated users. In other embodiments, coordinated activity determiner 508 uses the counts of collisions to decide which users should be examined in greater detail to then determine coordinated activity.

Coordinated activity determiner 508 may determine which users are most worth comparing in a deeper analysis to check whether or not the users are similar. An in-depth analysis of user accounts can be used to generate a list of potentially coordinated activity among users that have collided often. In some embodiments, the number of user accounts subsequently analyzed can be limited by excluding those who have broadcast fewer than some total threshold of messages because they are unlikely part of an information campaign. Yet another way to manage processing messages is to only analyze users that have broadcast a total of messages greater than some threshold over a period of time. The final list should include the number of times that each group of users has collided.

### 6. Comparing User Accounts

User account comparator 510 may be used to compare the accounts of users that have collided often to determine a degree of similarity. The number of groups of users investigated can be limited by sorting the list of user-groups and analyzing only the most suspicious examples until a predefined computational time is met or until the entire list is analyzed. The list may be sorted by the number of total collisions between users (e.g., users with 900 or more collisions).

An in-depth comparison between user accounts may not rely solely on uncommon features. Other parts of messages may be analyzed, such as words, hash tags, and the like. This type of analysis is a more expensive comparison because there are more features to compare against each other.

A metric may be used to determine what fraction of overlap exists between accounts from different users. For example, a group of two or more users at the top of the list is analyzed first. A list of all the messages from the group of users at the top of the list is sent to user account comparator 510 to determine similarity of behavior (e.g., 93 percent similar features). The process iterates down the list over each user-group. The value indicative of similar behavior for each user-group is stored in a database. These values are used to assess whether or not a number and/or frequency of collisions is actually an indication of coordinated activity. For example, users may have 800 collisions but this may represent only 7% of the number of messages broadcast by the users. The in-depth analysis is performed on each group of users until a predetermined period of time is met or the entire list has been analyzed.

Data indicating a fraction of similar activity between two or more user accounts may be outputted to decide whether or not two or more users are engaged in coordinated activity. These outputs may be provided to an administrator who is responsible for making a final decision of whether not to terminate user accounts that are suspected of engaging in coordinated activity. In other embodiments, these outputs may be used to automatically terminate accounts that exceed a threshold of common social media content.

### V. Data Visualization

Visualization tool 512 may provide a graphical interface to visualize relationships between users. Visualization tool 512 may be accessed over network 102 by a user operating a computing device with a display screen and a web browser that renders a user interface. The user interface may be provided by a web server stored in detector 104 and managed by visualization tool 512. The displayed user interface may include links to access many of the tools detailed below. In some embodiments, visualization tool 512 may only be accessible locally by an administrative computing device connected to detector 104. For brevity, this disclosure describes access of visualization tool 512 by a local administrator of detector 104.

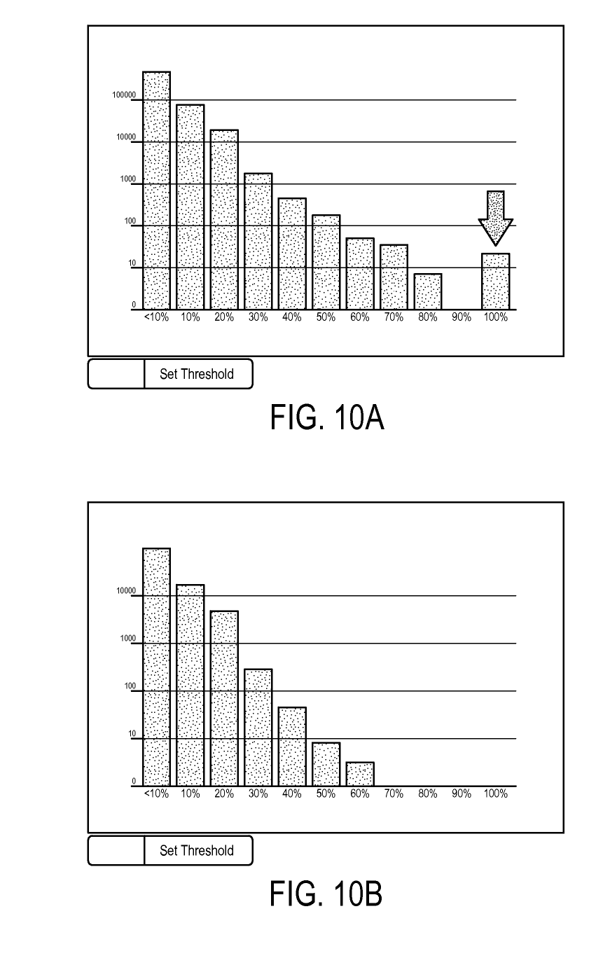

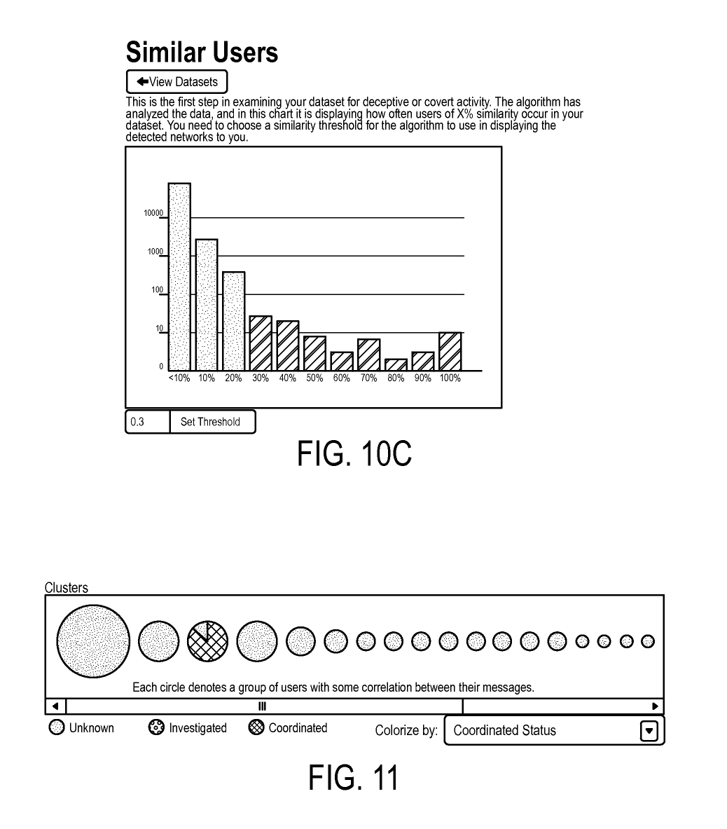

An alert may be sent to an administrator by visualization tool 512 to indicate that user account comparisons are complete and ready for analysis. Visualization tool 512 may render a histogram that shows fractions of users with degrees of similarity, as shown in FIGS. 10(A-C). For example, a histogram may display a fraction of user accounts that are 90 percent similar, 80 percent similar, and so on. The histogram allows an administrator to determine different levels of similarities that exist in social networks, and allows the administrator to set a threshold for subsequent investigation. For example, an administrator can examine users that are 50 percent or more similar.

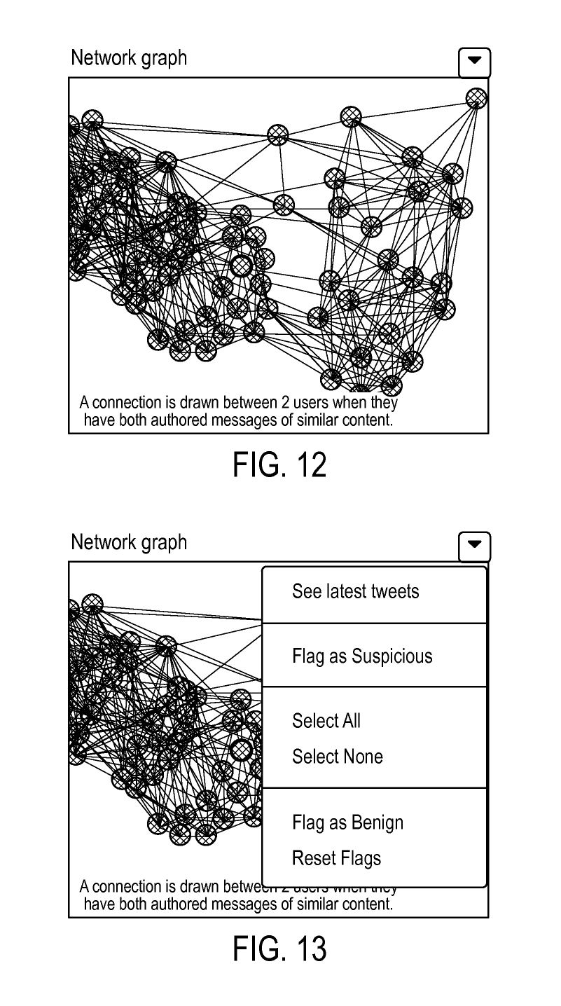

In some embodiments, data output by visualization tool 512 can be graphed to visualize relationships between users. FIG. 12 shows a “Network graph” generated by visualization tool 514 that includes nodes that can be shaded in different colors to represent users of suspected coordinated activity. Specifically, FIG. 12 shows nodes in a network graph that represent different user accounts and lines connecting the nodes that represent relationships between the user accounts. Each line can vary in width to indicate degrees of similarity between user accounts. For example, users that are 90 percent similar are represented with thicker connecting lines than users that are 50 percent similar.

The network graph can be changed by selecting different threshold values that correspond to different degrees of similarity between user accounts. Relationships can also be displayed according to different times of a particular date. Visualization tool 512 can render multiple views according to different comparison thresholds, different times, or combinations thereof.

Selecting a lower threshold displays a network graph with more nodes and complex interconnections. Selecting a higher threshold displays a network graph with fewer nodes and interconnections. Graphs with lower thresholds contain less useful information than graphs with higher thresholds because more nodes that represent a smaller degree of similarity are not a good indicator of coordinated activity. An administrator can select a threshold to determine what qualifies as coordinated activity. Using a higher threshold increases a confidence value that user accounts are engaged in coordinated activity because their degree of similarity is very high.

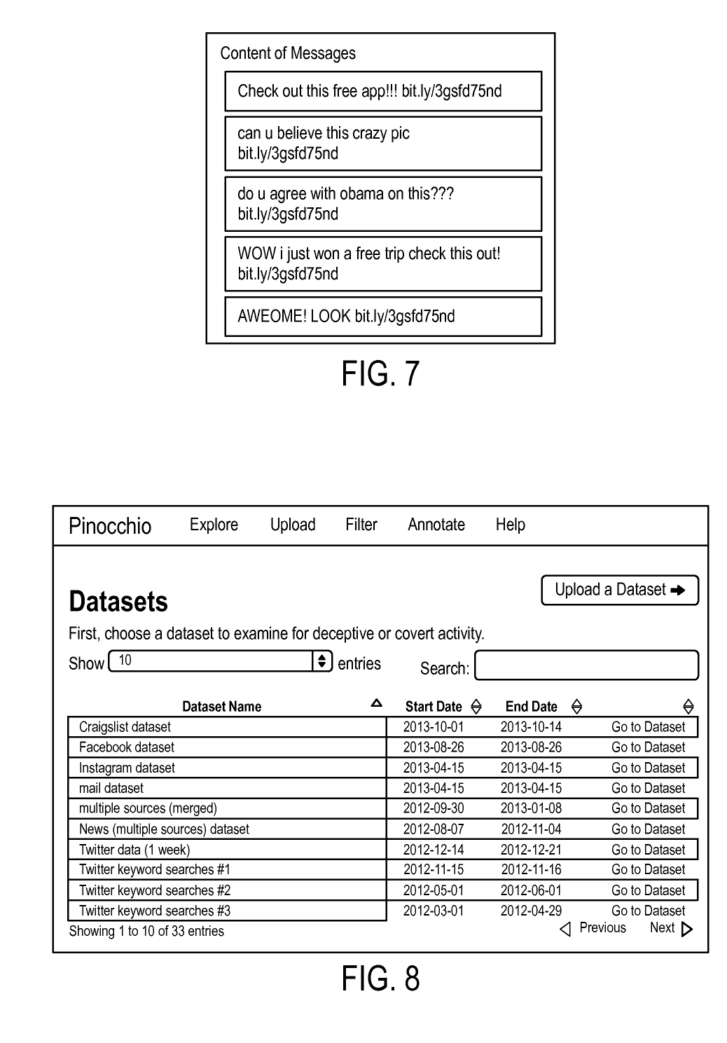

Users that are not directly connected have intermediate nodes that may be used to determine if they too are part of a coordinated activity. Clicking on sub-parts of the network graph displays a sub-group of users that share some connections. Clicking on an individual node displays information about a corresponding user account. FIG. 7 shows a list of TWITTER tweet messages generated by a user that are displayed when the user's node is clicked in the network graph. For example, clicking a node for Sam will show a list of messages posted by Sam that have been analyzed by detector 104.

An administrator can follow the node from Sam to a node representing a different user and click on the latter node to see messages belonging to the different user. The administrator can click back and forth between user accounts, or display both lists of messages simultaneously to identify coordinated activity. The determination about whether or not users are coordinated may be used for subsequent user intervention, such as terminating user accounts.

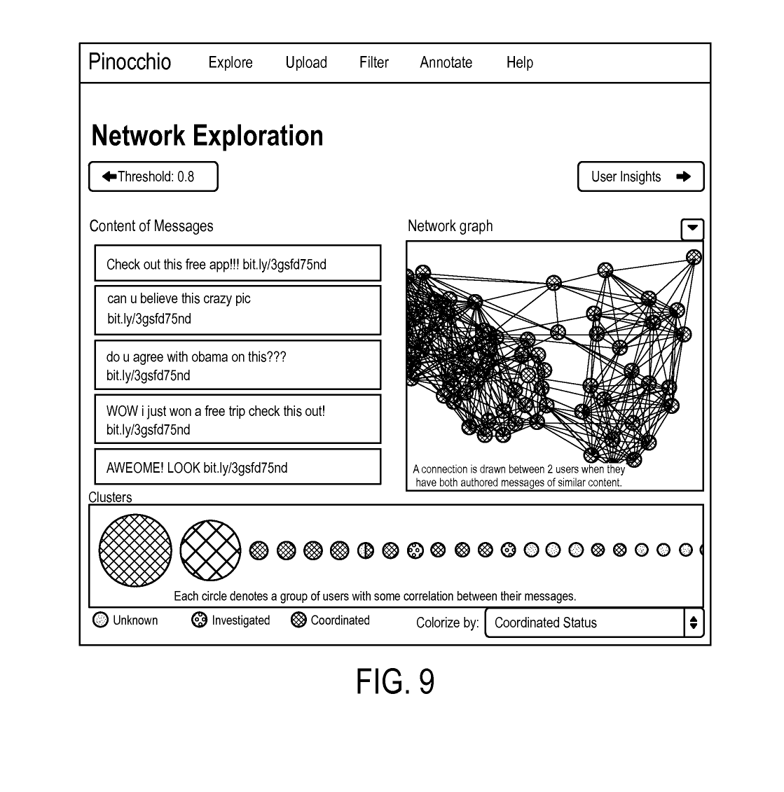

FIG. 9 shows a “Network Exploration” display screen of the user interface generated by visualization tool 512, at a point in the workflow where an administrator has selected a cluster of users and an individual user for inspection. The user interface includes menu options to explore, upload, filter and annotate data generated by detector 104. The “Explore” screen corresponds to the “Network Exploration” screen shown in FIG. 9. Selecting “Upload” on the screen shown in FIG. 9 allows an administrator to add a dataset to visualization tool 512. Selecting “Filter” on the screen shown in FIG. 9 allows an administrator to remove messages from a dataset. Selecting “Annotate” on the screen shown in FIG. 9 allows an administrator to tag a dataset with supplemental information stored in an insights database at detector 104. Details of each of these menu options are provided below.

Clicking on the threshold button shown in the “Network Exploration” display screen of FIG. 9 renders a histogram of user accounts with different degrees of similarity. FIGS. 10(A-C) show different bar graphs, where each bar represents the number of user accounts with a particular range of similarity. This allows the administrator to analyze activity by users who are as or more similar than a selected threshold. A good choice for a similarity threshold is often a bar that has an increased value from the previous bars as shown in FIG. 10A. If there are no bars like that, as shown in FIG. 10B, it is possible that the selected dataset does not contain any coordinated activity. An administrator can choose a threshold by inputting a value and clicking “Set Threshold” as shown in FIGS. 10(A-C).

FIG. 11 shows a “Clusters” box that includes a number of circles. Each circle represents a group of similar users. The size of each circle represents how many users are in the group. Colors may be used to represent how many of those users fall into a category. For example, blue colored circles may indicate that no one has investigated those users; gray colored circles may indicate that someone has investigated those users and found that the users are not involved in a coordinated activity; and red colored circles may indicate that someone has investigated those users and decided the users are involved in a coordinated activity. Even if this is a new dataset, visualization tool 512 will remember users from previous datasets and may color the cluster circle based on those investigations.

An administrator can click on a cluster and it will appear in the “Network graph” box shown in FIG. 12, with users represented by circles that are connected by lines if they have similar messages.

Clicking on one of the user nodes will show sample messages, such as TWITTER tweets, that will appear in a list, as shown in FIG. 7. This allows an administrator to compare messages of related users; often their messages will be identical, which can be a sign of coordinated activity.

An administrator may click the down arrow at the upper right of the “Network graph” box shown in FIG. 9 to display a dropdown menu and mark that user as coordinated, investigated (but not coordinated), or reset its status to not investigated. FIG. 13 shows the dropdown menu over the “Network graph” that can be used to mark a node. This marking will be recorded and maybe used in future analyses.

Clicking on one of the two arrow buttons at the top of the screen shown in FIG. 9 will cause the screen to go back to choose a different threshold or to move forward and examine user insights for a user currently selected.

A user's current TWITTER feed, if available, is displayed in the “Twitter Feeds” box shown in FIG. 7. In the “Insights” box, all of the information that visualization tool 512 has about this user is displayed. For example, this information may include whether anyone has investigated the user for coordinated activity and, if they have, whether it was determined to be coordinated or not. Insights about the user's demographic information can also be displayed.

Selecting “Upload” in FIG. 9 displays the screen shown in FIG. 8. An administrator can find a dataset of interest by using the search bar for a dataset name, or sort by dataset name, start date, or end date. Once the administrator finds a desired dataset, the administrator can click “Upload a Dataset” to begin analyzing it.

To add a dataset, it must be available in a proper format, such as a JSON file, or in another reformatted file. This file can be in any format as long as it includes at least the following four fields: message body and ID, user ID, and screen name. As detailed above, detector 104 supports many formats, including TWITTER, GNIP, and flat. If the file is not in one of these formats, then the administrator can choose “other format” and tell visualization tool 512 the field names of those four fields in the file.

Once the JSON file has been selected, the administrator gives the dataset a name of choice, tell detector 104 what format it is in, and may enter the administrator's name and the start and end date of the dataset in “yyyy-mm-dd” format, for example.

The administrator then clicks “Upload to Dataset.” The administrator should then see a link to explore the new dataset. The link will also be available under the administrator's dataset name in the user “Explore” screen. If the dataset is large, this link may not work right away and the administrator should wait for several minutes to a day (depending on the size of the dataset) and try again. If the administrator has not accurately described the dataset's format, or if it is so large that detector 104 cannot process it, then the upload may fail and the link will not work. The administrator can contact technical support resources if this happens.

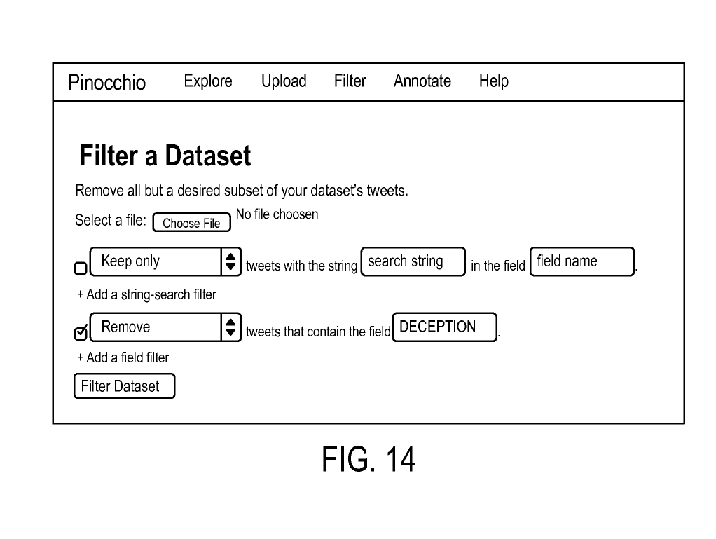

FIG. 14 shows the “Filter a Dataset” screen that is displayed by clicking the “Filter” menu item shown in FIG. 9. In some embodiments, a displayed graph allows an administrator to parse information according to various different topics of interest or unique opinions. The administrator can filter nodes and connections based on a particular feature. For example, an administrator can filter the graph for nodes of users who broadcast messages that include the feature values “repeal the law.”

An administrator can filter a dataset to include or exclude messages that match a particular search string. For example, a “string search” looks for TWITTER tweets that have a certain substring within a certain field, and may not be case sensitive (e.g., so “power” would match “MY POWER IS OUT!”). A “field search” can look for TWITTER tweets that have a certain field, such as TWITTER tweets that contain a Geotag field.

An administrator can apply multiple string search and field search filters to a dataset, simultaneously. For example, an administrator can select “Add a string-search filter” or “Add a field filter,” as shown in FIG. 14. The filters are combined because they include the Boolean operator AND between them. Accordingly, filters with “Keep only Twitter tweets with string Alex in field User” AND “Keep only Twitter tweets with string Sarah in field User” retrieves Twitter tweets with both “Alex” AND “Sarah,” and discards the rest.

A nested field can be referred to when applying a filter by using the “->” operator. For example, to refer to “dog” in {“owner”:“Laura”,“pets”: {“cat”:“Vesper”,“dog”:“Max′}} an administrator can use “pets->dog.”

Once the administrator clicks the “Filter Dataset” button shown in FIG. 14, a dialog box will appear that allows the administrator to save the filtered JSON file. The operator can then use the Upload link to add the filtered dataset to visualization tool 512.

A dataset can also be annotated by selecting the “Annotate” link shown in FIG. 9. FIG. 13 also shows a dropdown menu over the network graph that can be used to annotate data associated with a user represented by a node. The administrator can select different parts of a graph and mark the graph with flags and notes that can be stored. This ability to dynamically analyze relationships between users facilitates determining coordinated activity.

Visualization tool 512 keeps a database of known insights about users. A user may be flagged as having participated in coordinated activity, for example, or flagged as having an unusually high “Twitter tweets-to-followers” ratio. Annotating allows the operator to mark a JSON file with this type of information.

To annotate a file of messages, the file should be in a reformatted form. The file can then be selected and visualization tool 512 is told which format the file is in. Then clicking Annotate Dataset executes the annotation. A dialog box will pop-up to prompt the administrator to save the annotated file. This file is the same file that the administrator submitted with the addition of an “insights” flag in every message made by a user who has known insights stored in detector 104.

### VI. Additional Features

Different learning techniques may be used by detector 104 to improve subsequent detection results. For example, a dataset with messages related to a particular topic, such as election data, may be processed to identify coordinated users. An analysis of a dataset of related messages, such as opinions about healthcare law, can identify another group of coordinated users based on the identified users from the dataset of election data. These two data sets can be loaded on visualization tool 512 to shows relationships between coordinated users in these two groups. This may show, for example, twenty new coordinated users that are connected between the datasets that were missed when a dataset was processed. In this manner, an analysis of a dataset can be used to augment detection of coordinated users in another dataset.

In some embodiments, historical data can be used to improve subsequent detection results. For example, a dataset with known coordinated users can be uploaded to augment a subsequent analysis of the dataset collected later in time to identifying relationships between known and possible coordinated users.

In some embodiments, the visualization tool 512 may color code known coordinated users in the network graph differently than suspected users and users that are not coordinated. This facilitates detecting suspected coordinated users that are associated with known coordinated users. Thus, an ability to detect coordinated users improves over time by knowing other coordinated users because a previous analysis is used to improve a subsequent analysis of suspected users. This also eliminates having to rediscover the same coordinated users repeatedly in different datasets, over time. However, these learning techniques may require not terminating user accounts of known coordinated users or delaying their termination to use their account information as a basis for learning new coordinated users.

In some embodiments, feature types are content-based, time based, or profile metadata based. Non-content based features may be used in an analysis. These features may include times when messages are posted. For example, messages posted by users during a first time period may stored in a first dataset. Messages posted by the same users during a second time period may be stored in a second dataset. A feature can then be defined as the pair of datasets. The pair of datasets can then be searched as a feature associated with other users. Like an n-gram feature, the time-based feature is reduced to a hash value for to optimize counting. Thus, user behavior is reduced to a set of features that fit into the same space in memory that would contain other features. This may be a space of 64 bit numbers and used with content-based feature set. Other non-content based features may include colors, images and profile metadata. For example, a background color that is used by only five users is an uncommon feature that is a potential indicator of coordinated users. Collisions for all these types of features get counted to decide whether or not to conduct a similarity analysis.

The number of features analyzed for each message can vary and may depend on the type of messages generated in a particular social networking service. For example, micro-blogging messages like TWITTER tweets limit the amount of content in each message. Consequently, fewer content-based features are generated, especially with words n-grams rather than character n-grams. Using a similar feature detector for profile information can add even more features to a total number of features analyzed. Notably, analyzing the content of messages is relatively fast, highly informative and intuitive. In contrast, analyzing features in profile information requires additional time to retrieve profile information linked to messages.

In practice, hundreds of features per message could be analyzed. Another filtering step, in addition to thresholding, could further reduce the number of features in an inverted index. For example, a filter could exclude features related to a specific topic to further limit the features in an inverted index. However, experimental measurements of features show that only about 10 to 20% of features remain after thresholding because many features tend to occur once. For example, people tend to create unique messages with features that are excluded because they are identified only once. On the other hand, many features are extremely common in social media, like “http://www.” These features are excluded and ultimately reduce the number of features in the inverted index.

The described systems and methods can be implemented in any type of social media from different service providers. Since messages are standardized prior to a detection analysis, messages from different types of service providers are easily compared. In other words, some embodiments may analyze messages across different service providers. Messages from each service provider may be downloaded and reformatted, where common fields in different types of messages are tagged and compared among all messages. The output from this type of analysis can be used to identify the same coordinated user in different service providers. For example, law enforcement officials can identify the extent of criminal activity across multiple service providers after a criminal user has been identified in a single service provider. The user accounts from different service providers could appear linked in a network graph.

In some embodiments, detector 104 may be combined with various analytics tools operating together as a social radar system. Social radar technology may identify trends in social media in the same way that existing forms of radar identify objects in the sky. The output from detector 104 could be input into different analytics tools that are part of the social radar system. Visualization tool 512 can be part of a combined desktop view of the various analytics operating together. Information collected from these analytics tools can measure social moods of people at particular locations or identify particular social groups that are targeted by information campaigns.

In some embodiments, detector 104 can improve predictions about social moods by filtering-out social media that is biasing the prediction. For example, social media generated by people at a particular geographic location may suggest that the people are generally feeling frustrated about a new social policy. However, the analysis may be incorrect due to a bias introduced by coordinated activity from an organization against the new social policy.

In some embodiments, detector 104 can alert a user about another user in her social network that is suspected of coordinated activity. The deceived user can be presented with a list of suspected users to disassociate or to modify the amount or type of social media received from the suspected user. Detector 104 could also create a blacklist of suspected coordinated actors. In some embodiments, a service provider can build a list of suspected coordinated users and publish the list in a public location for other users to view.

In some embodiments, service provider 106 can upload a dataset of social media messages through an online portal that accesses detector 104 to pay for an analysis of the dataset on demand. The output could be returned to service provider 106 via the online portal. This allows social networking service providers to police their users by using detector 104 on demand.

In some embodiments, detector 104 could be used by any online service that posts informal content generated by users for other users to view. For example, detector 104 can detect users engaged in coordinated activity on websites like Craigslist. Posted content such as phone numbers, sales pitches, and email addresses may be used as uncommon features. Coordinated users are detected their names can be relayed to law enforcement officials. For example, a bicycle thief may sell stolen merchandise on Craigslist by masquerading as different private users. Detector 104 can detect the criminal engaged in this type of criminal activity. In addition, detector 104 can be used to detect venders that are masquerading as individuals selling products online.

Data companies such as GNIP, TOPSY and DATASIFT could benefit from detector 104 because it would allow the companies to detect and remove deceptive messages from social media. Thus, the data companies can sell social media data that is of higher quality because it reflects a more accurate representation of opinions from real users and excludes a bias imputed by coordinated users.

Although various embodiments, each of which incorporates the teachings of the present invention, have been shown and described in detail herein, those skilled in the art can readily devise many other embodiments that still utilize these teachings. The various embodiments described above have been presented for purposes of illustration and description. They are not intended to be exhaustive or to limit the invention to the precise forms disclosed, and many modifications and variations are possible in light of the above teaching. For example, detector 104 can be applied to any dataset to identify repeated behavior in systems where the repeated behavior is not expected or desired, such as a plagiarism detection system. The invention can be construed according to the Claims and their equivalents.

1. A method for preparing a dataset of uncommon features, comprising:
retrieving a dataset comprising a plurality of social media messages stored in a memory, wherein the plurality of social media messages are authored by a plurality of users of one or more social media services;
extracting, using a processor, a plurality of features from the plurality of social media messages, wherein each of the extracted features is associated with a user that authored a social media message comprising the extracted feature; and
determining that the extracted features are uncommon features when a count for each of the extracted features exceeds a first threshold and is less than a second threshold.

2. The method of claim 1, wherein the uncommon features are stored in a dataset of uncommon features, and an uncommon feature is removed from the dataset of uncommon features when another extracted feature is determined as an uncommon feature and a quantity of uncommon features stored in the dataset of uncommon features exceeds a third threshold.

3. The method of claim 1, wherein the one or more social media services comprise FACEBOOK or TWITTER.

4. The method of claim 1, wherein the plurality of social media messages are authored by a plurality of users of two or more social media services.

5. The method of claim 4, wherein the social media messages from the two or more social media services are reformatted into a common format before features are extracted.

6. The method of claim 1, wherein each of the extracted features is passed through a hashing algorithm to convert each of the extracted features into hash values.

7. A method for detecting coordinated social media activity, comprising:
providing a dataset comprising a plurality of uncommon features stored in a memory; and
determining, using a processor, a number of collisions for social media messages authored by two or more users, wherein each collision is detected as an uncommon feature from the plurality of uncommon features that is present in a message authored by each of the two or more users.

8. The method of claim 7, further comprising:
comparing user account information of the two or more users when their number of collisions exceeds a first threshold.

9. The method of claim 8, further comprising:
determining whether or not the two or more users are coordinated when a degree of similarity between their user account information exceeds a second threshold.

10. The method of claim 9, wherein the user account information comprises social media messages and user profile information.

11. The method of claim 7, further comprising:
determining a feature count for each of the plurality of uncommon features, wherein the feature count for each uncommon feature is incremented when the uncommon feature is detected in social media messages that are authored by more than one user.

12. The method of claim 11, wherein an uncommon feature is removed from the dataset comprising the plurality of uncommon features when a feature count for the uncommon feature exceeds a third threshold.

13. The method of claim 7, further comprising:
visualizing, on a display, a network graph that represents relationships between the two or more users, wherein nodes represent users and lines connecting nodes represent collisions between the users.

14. The method of claim 13, further comprising a histogram that shows different degrees of similarity between user account information.

15. The method of claim 7, wherein a hashing algorithm is applied on each detected collision to obtain a hash value.

16. A method for visualizing users that are suspected of engaging in coordinated activity in social media, comprising:
generating, on a display, a network graph of a plurality of users that are suspected of engaging in coordinated activity, wherein each node in the network graph represents a user and each line connecting nodes represents a quantity of features identified in social media messages that are authored by users represented by the nodes connected by each line.

17. The method of claim 16, further comprising:
changing a threshold value of a degree of similarity between the users that are represented by the nodes, wherein increasing the threshold value decreases a quantity of nodes in the network graph, and decreasing the threshold value increases the quantity of nodes in the network graph.

18. The method of claim 17, further comprising:
identifying users engaging in coordinated activity based on a quantity of nodes and their connecting lines in the network graph, and the threshold value.

19. A system for preparing a dataset of uncommon features, comprising:
a memory for storing a dataset comprising a plurality of social media messages, wherein the plurality of social media messages are authored by a plurality of users of one or more social media services; and
a processor for extracting a plurality of features from the plurality of social media messages, wherein each of the extracted features is associated with a user that authored a social media message comprising the extracted feature, and
for determining that the extracted features are uncommon features when a count for each of the extracted features exceeds a first threshold and is less than a second threshold.

20. The system of claim 19, wherein the uncommon features are stored in a dataset of uncommon features, and an uncommon feature is removed from the dataset of uncommon features when a quantity of uncommon features stored in the dataset of uncommon features exceeds a third threshold.

21. The system of claim 19, wherein the plurality of social media messages are authored by a plurality of users of two or more social media services that are configured to communicate with the plurality of users over the Internet.

22. A system for detecting coordinated social media activity, comprising:
a memory that stores a dataset comprising a plurality of uncommon features stored in a memory; and
a processor for determining a number of collisions for social media messages authored by two or more users, wherein each collision is detected as an uncommon feature from the plurality of uncommon features that is present in a message authored by each of the two or more users.

23. The system of claim 22, wherein the processor is configured to compare user account information of the two or more users when the number of collisions exceeds a first threshold.

24. The system of claim 23, wherein the processor is configured to determine whether or not the two or more users are coordinated when a degree of similarity between their user account information exceeds a second threshold.

25. The system of claim 23, wherein the user account information comprises social media messages and at least one of user profile information and metadata.
